(19) United States
(12) Patent Application Publication
(10) Pub. No.: US 2019/0149327 A1
(43) Pub. Date: May 16, 2019

(54) METHOD AND SYSTEM FOR QUANTUM KEY DISTRIBUTION AND DATA PROCESSING

(71) Applicant: Alibaba Group Holding Limited, George Town (KY)

(72) Inventors: Peng Yuan, Beijing (CN); Chongjin Xie, Morganville, NJ (US)

(73) Assignee: Alibaba Group Holding Limited, George Town, Grand Cayman (KY)

(21) Appl. No.: 16/189,615

(22) Filed: Nov. 13, 2018

(30) Foreign Application Priority Data
Nov. 14, 2017 (CN) 201711125199.0

(51) Int. Cl. H04L 9/08

(52) U.S. Cl. CPC H04L 9/0852; H04L 2209/043; H04L 9/0891; H04L 9/0866

(57) ABSTRACT

One embodiment described herein provides a system and method for distributing quantum keys between first and second applications running on first and second client devices, respectively. During operation, a first application running on the first client device can transmit a first key request to a first quantum-key-management (QKM) module managing a first set of quantum keys, and transmit a notification to the second application running on the second client device, the notification prompting the second application to transmit a second key request to a second QKM module managing a second set of quantum keys. The first application can receive, from the first QKM module, a first quantum key based on the first key request, in response to the first QKM module determining that the second application receives a second quantum key based on the second key request.

### RELATED APPLICATION

Under 35 U.S.C. § 119, this application claims the benefit and right of priority of Chinese Patent Application No. 201711125199.0, filed on 14 Nov. 2017.

### BACKGROUND

### Field

This disclosure is generally related to quantum communication. More specifically, this disclosure is related to a system and method for quantum key distribution and data processing.

### Related Art

In recent years, research efforts in quantum communications, more particularly quantum cryptography, have made significant progress. In addition to the original Bennett-Brassard-84 (BB84) quantum-key-distribution (QKD) protocol, a number of QKD protocols, such as SARG04 (which is derived from BB84), differential-phase-shift (DPS), coherent one-way (COW), etc., have been developed to increase the efficiency of the QKD process.

Quantum communication involves encoding information in quantum states (also referred to as qubits). More specifically, the quantum states (or qubits) can be transmitted in a quantum channel to facilitate generation and secure distribution of encryption keys at both ends of a secure communication channel. These encryption keys, also referred to as quantum keys, can then ensure security of the information exchanged between the two end nodes of the secure channel. In current approaches, the equipment for generating the quantum keys and the equipment for data encryption/decryption are often integrated into a single device, thus leading to inflexibilities in the utilization of the quantum encryption devices. There are many applications that require encryption/decryption operations and many different protocols (e.g., cryptographic protocols) may also be involved. Different encryption/decryption applications may require different types of encryption/decryption equipment. Designing specialized equipment for each application can be very costly to users.

### SUMMARY

One embodiment described herein provides a system and method for distributing quantum keys between first and second applications running on first and second client devices, respectively. During operation, a first application running on the first client device can transmit a first key request to a first quantum-key-management (QKM) module managing a first set of quantum keys, and transmit a notification to the second application running on the second client device, the notification prompting the second application to transmit a second key request to a second QKM module managing a second set of quantum keys. The first application can receive, from the first QKM module, a first quantum key based on the first key request, in response to the first QKM module determining that the second application receives a second quantum key based on the second key request.

In a variation on this embodiment, the first key request can include parameters associated with the first quantum key, and the parameters associated with the first quantum key can include a length or a sequence number associated with the first quantum key.

In a further variation, the notification can include the parameters associated with the first quantum key.

In a further variation, the first QKM module can perform a lookup operation in the first set of quantum keys based on the parameters associated with the first quantum key. In response to determining that the first set of quantum keys includes the first quantum key, the first QKM module can obtain the first quantum key; and in response to determining that the first set of quantum keys does not include the first quantum key, the first QKM module can return a failure message to the first application.

In a variation on this embodiment, the first key request can include a device identifier associated with the second QKM module. The first QKM module can identify the second QKM module based on the device identifier and transmit a first key-sync message to the second QKM module. The first key-sync message indicates that the first quantum key is available.

In a further variation, the first key-sync message comprises parameters associated with the first quantum key.

In a variation on this embodiment, determining that the second client device receives a second quantum key can include receiving, from the second QKM module, a second key-sync message.

In a further variation, the second key-sync message comprises parameters associated with the second quantum key.

In a variation on this embodiment, the first and second sets of quantum keys are obtained via a quantum-key-distribution process; and the first and second quantum keys are symmetric encryption keys.

In a variation on this embodiment, the first application running on the first client device can update an encryption key using the first quantum key; and the second application running on the second client device can update an encryption key using the second quantum key, thereby establishing a secure communication channel between the first and second applications.

### BRIEF DESCRIPTION OF THE FIGURES

FIG. 1 illustrates a conventional quantum-key-distribution (QKD) system (prior art).

FIG. 2 presents a diagram illustrating the exemplary layered structure of a QKD system, according to one embodiment.

FIG. 3 illustrates an exemplary system initialization process, according to one embodiment.

FIG. 4 presents a time-space diagram illustrating an exemplary process for applications to obtain quantum keys, according to one embodiment.

FIG. 5 presents a diagram illustrating the exemplary architecture of a client device, according to one embodiment.

FIG. 6 presents a diagram illustrating the exemplary architecture of a quantum-key-management (QKM) module, according to one embodiment.

FIG. 7 presents a flowchart illustrating an exemplary quantum-key-distribution initiating process, according to one embodiment.

FIG. 8 presents a flowchart illustrating an exemplary quantum-key-distribution following process, according to one embodiment.

FIG. 9 illustrates an exemplary client-server network environment for implementing the disclosed quantum-key-distribution technology, in accordance with some embodiments described herein.

FIG. 10 conceptually illustrates an electronic system with which some implementations of the subject technology are implemented.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide a method and system for secure and efficient distribution of quantum keys. More specifically, in embodiments of the present invention, the generation and management of quantum keys and the encryption/decryption operations can be performed by modules that are separate and independent of each other. Standard interfaces and protocols can be developed to facilitate coupling among those modules. In one embodiment, a QKD system can include three independent modules (e.g., a quantum engine, a key-management platform, and a cryptographic application module) that form a hierarchical structure from the point of view of their functionalities. Prior to the distribution of the quantum keys, client devices can establish secure connections to their corresponding key-management platforms. A cryptographic application running on one client device can initialize a quantum-key-distribution process followed by the corresponding cryptographic application running on another client device. Each application can receive the quantum key from its corresponding key-management platform and uses the received quantum key to encrypt/decrypt data. The key-management platforms can also communicate with each other to ensure synchronization between the quantum keys sent to the two client devices.

### Principles of Quantum Key Distribution

According to quantum physics, some physical quantities of the microscopic world cannot continuously change but take on certain discrete values, and the difference between two adjacent discrete values is referred to as a “quantum,” e.g., a photon is a single quantum of light.

In traditional communication where laws of classical mechanics apply, digital information can be represented as bits, wherein each bit can have two states: e.g., “0s” and “1s,” or “high” and “low” voltages. In contrast, in quantum communication where laws of classical mechanics do not apply, information is typically represented as quantum bits (qubits), which are units of quantum information. Each qubit can have two basic states: |0> or ↔ and |1> or [symbol] . In this case, the two quantum states |0> and |1> form a quantum state basis, which can be expressed as {|0>,|1>}.

Moreover, a quantum quantity can also take on a mixed state obtained by the superposition of the two basic states with coefficients α, β, respectively. For example, if quantum basis {|0>,|1>} is used, then a mixed state can be expressed as:

|φ [symbol] =α|0 [symbol] +β|1 [symbol] .

For example, a mixed quantum state basis {|+ [symbol] ,|− [symbol] } can be generated by superpositioning the basic quantum states |0>/↔ and |1>/ [symbol] using the following formulae:

$$\vert + = \frac{↔ + β}{\sqrt{2}} , \\ \vert - = \frac{↔ - β}{\sqrt{2}} .$$

Note that in the above two bases of quantum state representations, states |0> and |1> are orthogonal to each other, while states |+> and |−> are orthogonal to each other.

In quantum mechanics, a given mechanical quantity can be measured using the above-described quantum states, which are also referred to as “measurement basis.” For example, each mechanical quantity can be expressed by a Hermitian operator (or Hermitian matrix). When measuring such a mechanical quantity, the measurement results correspond to the eigenvalues (or the “characteristic values”) of the Hermitian operator for this mechanical quantity. After the measurement, the quantum state being measured collapses to the eigenstates (or the “eigenvectors”) corresponding to the obtained eigenvalues. Table 1 illustrates two exemplary mechanical quantity measurement schemes based on using two different sets of quantum states in accordance with one embodiment described herein.

TABLE 1
Mechanical Quantity Measurement Using a Set of Quantum States

| | | |
|---|---|---|
| Mechanical Quantity | Eigenvalues: 1, −1 | Referred to as |
| $Z = ( \begin{matrix}1 & 0 \\ 0 & - 1\end{matrix} )$ | Eigenstates: \|0 [symbol] , \|1 [symbol] | measuring using set {\|0 [symbol] , \|1 [symbol] } |
| Mechanical Quantity | Eigenvalues: 1, −1 | Referred to as |
| $Z = ( \begin{matrix}0 & 1 \\ 1 & 0\end{matrix} )$ | Eigenstates: \|+ [symbol] , \|− [symbol] | measuring using set {\|+ [symbol] , \|− [symbol] } |

For example, when using quantum state basis {|0 [symbol] ,|1 [symbol] } to measure quantum state |ϕ [symbol] =α|0 [symbol] +⊕|1 [symbol] , wherein |α|²+|β|²=1, we will obtain a measurement value of 1 with a probability of |α|², wherein after the measurement the quantum state collapses to |0 [symbol] ; and we will obtain a measurement value of −1 with a probability of |β|², wherein after the measurement the quantum state collapses to |1 [symbol] .

As another example, when using quantum state basis {|0 [symbol] ,|1 [symbol] } to measure quantum state |0 [symbol] , we will obtain state |0 [symbol] with probability 1. Similarly, when using quantum state basis {|+ [symbol] ,|− [symbol] } to measure quantum state |+ [symbol] , we will obtain state |+ [symbol] with probability 1.

Furthermore, when using quantum state basis {|0 [symbol] ,|1 [symbol] } to measure quantum state |+ [symbol] , we will randomly obtain either state |0 [symbol] or state |1 [symbol] . Similarly, when using quantum state basis {|+ [symbol] ,|− [symbol] } to measure state |0 [symbol] , we will randomly obtain either state |+ [symbol] or state |− [symbol] .

Bennett-Brassard-84 (BB84) is a popular quantum-key-distribution protocol. BB84 uses the polarization states of single photons to transmit information. The usual polarization state pairs used are either the rectilinear basis of vertical (0°) and horizontal (90°), the diagonal basis of 45° and 135° or the circular basis of left- and right-handedness. Any two of these bases are conjugate to each other, so any two can be used in the protocol. In the BB84 scheme, sender Alice wishes to send a private key (e.g., a random string) to receiver Bob. Alice starts by generating a random bit and randomly selects from two quantum bases a quantum basis to encode the binary bit. Alice then transmits a single photon in the state specified to Bob, using the quantum channel. This process is then repeated from the random bit stage, with Alice recording the state, basis and time of each photon sent. Upon receiving a photon, Bob performs measurements using a randomly selected basis. Bob does this for each photon he receives, recording the time, measurement basis used, and measurement result. After Bob has measured all the photons, he communicates with Alice over the public classical channel. Alice broadcasts the basis each photon was sent in, and Bob the basis each was measured in. They both discard photon measurements (bits) where Bob used a different basis, which is half on average, leaving half the bits as a shared key.

To check for the presence of an eavesdropper Eve, Alice and Bob can compare a predetermined subset of their remaining bit strings. If a third party has gained any information about the photons' polarization, this introduces errors into Bob's measurements. Other environmental conditions can cause errors in a similar fashion. If the bit error rate is less than a predetermined threshold, error-correction techniques can be used to correct errors, and privacy amplification can be used to reduce Eve's knowledge of the key to an arbitrarily small amount at the cost of reducing the length of the key. If the bit error rate is greater than a predetermined threshold, they abort the key and try again, possibly with a different quantum channel, as the security of the key cannot be guaranteed.

### Modularized QKD Systems

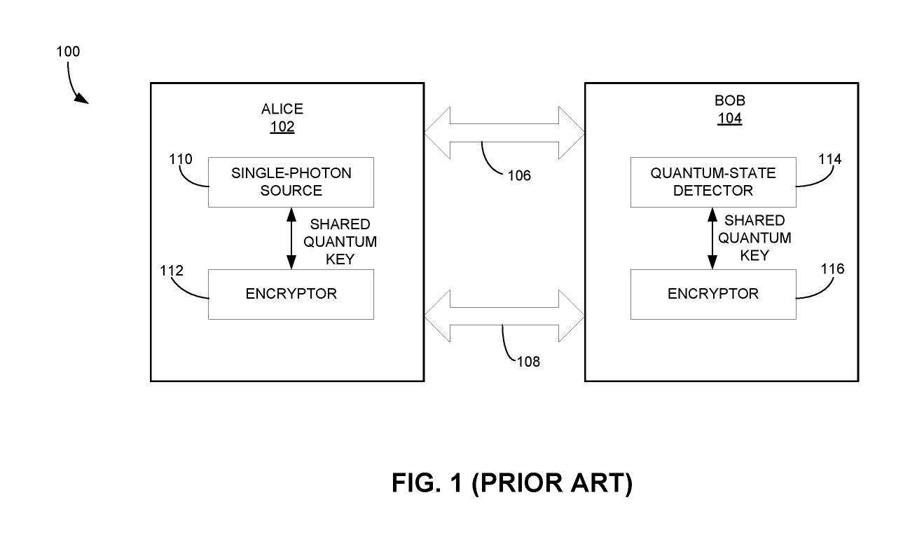

The conventional secure communication approaches that rely on a QKD scheme for key distribution often use a single device or module for both the generation of the quantum keys as well as the encryption of the information. FIG. 1 illustrates a conventional quantum-key distribution (QKD) system (prior art). In FIG. 1, QKD system 100 can include a sender (‘Alice”) 102 and a receiver (“Bob”) 104, a quantum channel 106, and a classical channel 108. Quantum channel 106 can preserve the quantum states, typically carried by single photons. For example, quantum channel 106 can include an optical fiber or direct line of sight free-space path. Classical channel 108 can include a conventional networked connection.

In FIG. 1, sender 102 can include a sigle-photon source 110 and an encryptor 112, and receiver 104 can include a quantum-state detector 114 and an encryptor 116. Sender 102 can send encoded single photons (i.e., qubits) produced by single-photon source 110 to quantum-state detector 114 of receiver 104 over quantum channel 106. The exchange of the encoded single photons between sender 102 and receiver 104 can follow the BB84 or other type of QKD protocol. The shared quantum key can then be sent to encryptors 112 and 116 to facilitate secure data communications between sender 102 and receiver 104 over classical channel 108. Whenever a new key is needed (e.g., when the old key times out), sender 102 can send a new set of encoded single photons to receiver 104.

In the example shown in FIG. 1, single-photon source 110 and encryptor 112 may be integrated onto a single device or module, and quantum-state detector 114 and encryptor 116 may be integrated onto a single device or module. In other scenarios, single-photon source 110 and encryptor 112 may be implemented as separate devices but are located on the same site (e.g., within a physical enclosure) and can be directly connected to each other via a wired connection. Similarly, quantum-state detector 114 and encryptor 116 may also be implemented as separate devices located at a same site. This integrated approach can be inconvenient and costly for users, especially in situations where different encryption protocols may be desired. To increase flexibility and lower the cost, embodiments of the present invention use a modularized and distributive approach to allow for the separation of quantum-key generation and data encryption.

In some embodiments, the various QKD functions (e.g., generation and exchange of the quantum keys, management of the quantum keys, and data encryption/decryption) of a QKD system can be divided into three hierarchical layers and can be performed by separate modules that operate independently of each other. A layered protocol can be implemented where information exchanged between the two communication parties (e.g., the sender and receiver) remains in each layer (i.e., there is no cross-layer information exchange). In other words, a respective module of one communication party only exchanges information with a corresponding module of the same layer of the other communication party. Information needing to be passed across layers can be exchanged vertically among modules associated with the same communication party.

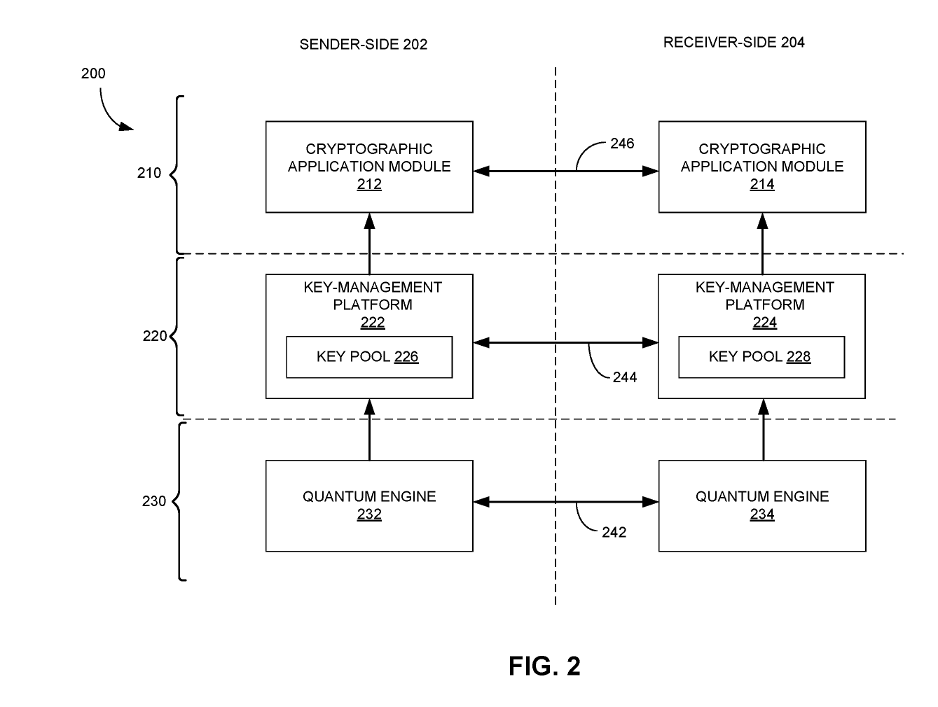

FIG. 2 presents a diagram illustrating the exemplary layered structure of a QKD system, according to one embodiment. QKD system 200 can include a sender-side 202 and a receiver-side 204. Each side can be divided into three stacked layers. More specifically, from top to bottom, the three layers are application layer 210, key-management layer 220, and key-generation layer 230. Sender-side 202 can include a number of modules that operate independently of each other. For example, on sender-side 202 there are cryptographic application module 212, key-management platform 222, and quantum engine 232. Key-management platform 222 can also include a key pool 226. Similarly, on receiver-side 204 there are cryptographic application module 214, key-management platform 224, and quantum engine 234. Key-management platform 224 can also include a key pool 228.

The quantum engines (e.g., quantum engines 232 and 234) are responsible for accomplishing quantum-key negotiation by performing various functions, including transmitting and receiving single photons, generating random numbers, selection of initial quantum keys, error correction, privacy amplification, security certification, etc. More specifically, quantum engines 232 and 234 can communicate over a quantum channel 242; generate, according to predetermined cryptography protocols, secure quantum keys; and transmit the generated quantum keys to corresponding key-management platforms. Quantum engine 232 transmits the generated quantum keys to key-management platform 222, which then stores the received quantum keys in key pool 226; and quantum engine 234 transmits the generated quantum keys to key-management platform 224, which then stores the quantum keys in key pool 228.

The key-management platforms (e.g., key-management platforms 222 and 224) store and manage quantum keys. In addition, they can respond to key requests from the cryptographic application modules. For example, cryptographic application module 212 can request encryption key(s) from key-management platform 222; and cryptographic application module 214 can request encryption key(s) from key-management platform 224. Key-management platforms of sender-side 202 and receiver-side 204 can communicate with each other via a classical channel 244.

Cryptographic application modules 212 and 214 can obtain encryption keys from key-management platforms 222 and 224, respectively, and then use the obtained encryption keys to establish a secure communication channel 246, which can be a classical channel.

As discussed previously, information exchanged between sender-side 202 and receiver-side 204 remains in the same layer, whereas information exchanged across the layers (e.g., the keys) is passed among modules on the same sender or receiver side. The secure passage of the information among these modules can easily be guaranteed if they are located on a same device. However, special care is needed when these modules are located on different devices to ensure security of the information. Moreover, strict key synchronization is needed between the cryptographic application modules 212 and 214. Embodiments of the present invention provide a quantum-key-distribution (QKD) protocol that facilitates the decoupling between the quantum-key-generation/distribution and the data encryption/decryption processes.

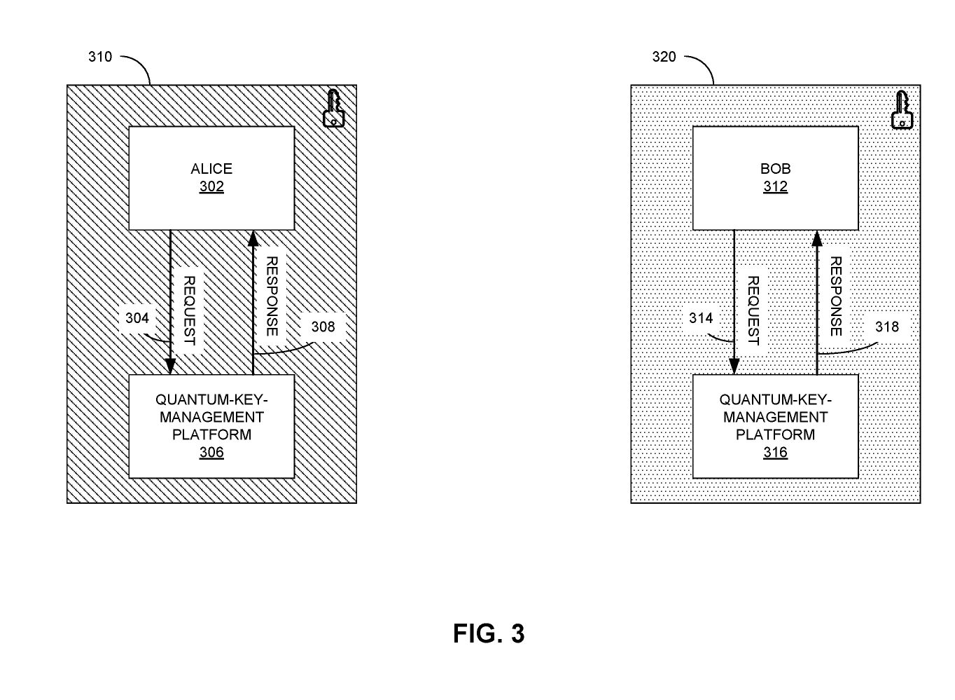

FIG. 3 illustrates an exemplary system initialization process, according to one embodiment. In FIG. 3, a client device (“Alice”) 302 can send a request 304 to establish a secure connection to a quantum-key-management (QKM) platform 306. QKM platform 306 can be implemented as a local server or server cluster. Alternatively, QKM platform 306 can be implemented as a cloud server or cloud server cluster. QKM platform 306 can be standalone or it can be integrated with client device 302 or the quantum-key-generation equipment. If QKM platform 306 runs on client device 302, QKM platform 306 may interface with an application running on client device 302 via an inter-process communication (IPC) mechanism. If QKM module 306 runs on a different device, an application running on client device 302 can interact with QKM module 306 via a network connection (e.g., a TCP data connection). To ensure information security, client device 302 and QKM platform 306 have been preconfigured such that they are in a same “secure zone” 310, meaning that communications between client device 302 and QKM platform 306 are protected.

In response to receiving request 304, QKM platform 306 can authenticate client device 302 according to a set of predetermined security policies (e.g., a set of static security rules), and send authentication response 308 to client device 302, thus facilitating a secure connection between client device 302 and QKM platform 306. Similarly, a client device 312 (“Bob”) can send a request 314 to QKM platform 316. Client device 312 and QKM platform 316 have been preconfigured such that they are in a same “secure zone” 320. In response to receiving request 314, QKM platform 316 can authenticate client device 312, and send authentication response 318 back to client device 312 to establish a secure connection between client device 312 and QKM platform 316. These secure connections ensure the security of communications between an application (e.g., a cryptographic application) running on a client device and the corresponding QKM platform (e.g., an application running on client device 302 and QKM platform 306).

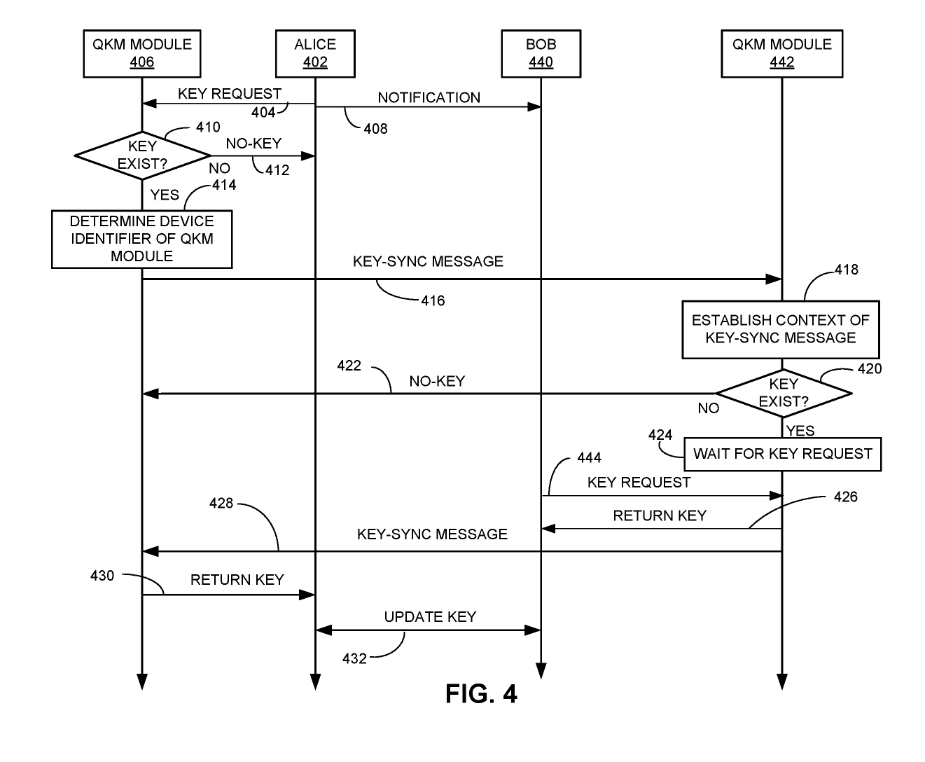

FIG. 4 presents a time-space diagram illustrating an exemplary process for applications to obtain quantum keys, according to one embodiment. During operation, an application running on a client device (“Alice”) 402 sends a key request 404 to quantum-key-management (QKM) module 406 via a pre-established secure link. Key request 404 can specify one or more parameters associated with the requested key or key block, including but not limited to the length of the requested key and whether the key is used for encryption or decryption. In addition, key request 404 can also specify the other communication party with whom the requested key is used to establish a secure communication channel. In this example, the other communication party is an application running on client device (“Bob”) 440, and key request 404 can include a device identifier identifying client device 440.

In addition to sending key request 404, client device 402 can send, substantially simultaneously, a notification 408 to the other communication party (i.e., client device 440), notifying the other communication party to send a key request to its corresponding key-management module (e.g., QKM module 442). Notification 408 needs to be sent simultaneously with or immediately after key request 404 in order for the other communication party to send its own key request in time, because each QKM module maintains a timer according to a predetermined communication time limit. If a key request sent to the QKM module exceeds the time limit, the QKM module will discard the key request and send a failure message to the other communication party. For example, in response to receiving notification 408, client device 440 can send key request 444 to QKM module 442, which will determine whether key request 444 is received after the predetermined time limit. If so, QKM module 442 can send a failure response to client device 440. QKM module 442 can also send the failure response to QKM module 406. In some embodiments, notification 408 can include information associated with the requested key. In other words, notification 408 can include key information included in key request 404. Alternatively, notification 408 does not include information associated with the requested key.

In response to receiving key request 404, QKM module 406 can perform a key-lookup in its managed key pool to determine whether a key having the requested length is available (operation 410). Note that, as discussed previously, the managed key pool stores a plurality of quantum keys (e.g., encryption/decryption keys generated using known quantum-key-generation schemes, such as BB84). If no such key exists in the key pool, QKM module 406 can send a no-key response back to client device 402 (operation 412). If a key satisfying the requested length can be found in the key pool, QKM module 406 can determine, based on key request 404, the device identifier of the corresponding QKM module of the other communication party (e.g., the device identifier of QKM module 442) (operation 414). QKM module 406 can then send a key-sync message 416 to QKM module 442.

Key-sync message 416 can include information associated with the key or key block needed by the application running on client device 440 without including the key itself. More specifically, key-sync message 416 can include information such as the length of the key and/or the sequence number of the key. If symmetric keys are used, key-sync message 416 can include information about the key specified by key request 404. Note that the sequence of key request 444 and key-sync message 416 can be arbitrary. Key-sync message 416 can be sent before, after, or at the same time as key request 444. In some embodiments, key request 444 can be sent after key-sync message 416, as shown in FIG. 4.

In response to receiving key-sync message 416, QKM module 442 can first establish the context of key-sync message 416 (e.g., based on previously received key-sync messages) (operation 418) and then determine whether a quantum key or key block having the characteristics specified in key-sync message exists in its key pool (operation 420). If no such key exists, QKM module 442 can send a no-key message 422 to QKM module 406. Otherwise, QKM module 442 waits for key request 444 from the application running on client device 440 (operation 424).

In response to receiving key request 444, QKM module 442 returns the requested key to the application running on client device 440 (operation 426). Note that, if key-sync message 416 is received by QKM module 442 after key request 444, QKM module 442 waits for key-sync message 416 before sending the requested key to the application running on client device 440.

Subsequent to sending the requested key to the application running on client device 440, QKM module 442 can send a key-sync message 428 to QKM module 406, notifying QKM module 406 that the requested key has been sent to the application running on client device 440. Key-sync message 428 can include information associated with the key sent by QKM module 442 to the application running on client device 440, thus allowing QKM module 406 to verify whether a correct key has been sent by QKM module 442. In response to receiving key-sync message 428, QKM module 406 returns the requested key to the application running on client device 402, thus completing the key distribution process (operation 430). Note that QKM module 406 also maintains a timer according to the predetermined communication time limit. QKM module 406 tracks the interval between the key request and the key return. If the timer expires before QKM module 406 can return the key to the application running on client device 402, QKM module 406 can discard the key request and return a failure message to the application running on client device 402.

At this moment, both applications running on client devices 402 and 440 have received the requested shared key and, hence, are ready to establish a secure communication channel using the shared key. More specifically, each application can update the encryption/decryption key using the received shared key (operation 432). Standard key-updating mechanisms can be used here.

In the example shown in FIG. 4, the key-distribution process is directional. More specifically, the application running on client device 402 (Alice) is the initiator that determines what kind of key will be used, whereas the application running on client device 440 (Bob) is the follower. The initiator initiates the key-distribution process by requesting a key from a corresponding QKM module and by notifying the follower that a key is being requested. On the other hand, the follower requests the same key from its own QKM module and notifies the initiator once the key is obtained. The key-sync messages communicated between the QKM modules of the initiator and follower ensure that the keys obtained by both applications are identical. On the other hand, during the key-update operation, client device 440 (Bob) can be the initiator and client device 402 (Alice) can be the follower.

The key-distribution process shown in FIG. 4 can be used in various types of communication scenario requiring data encryption/decryption, such as point-to-point communications, communications between the base station and routers in Wi-Fi®, communications between a mobile terminal and a home appliance in smart homes, communications in the Internet of things (IoT), cloud communications, etc.

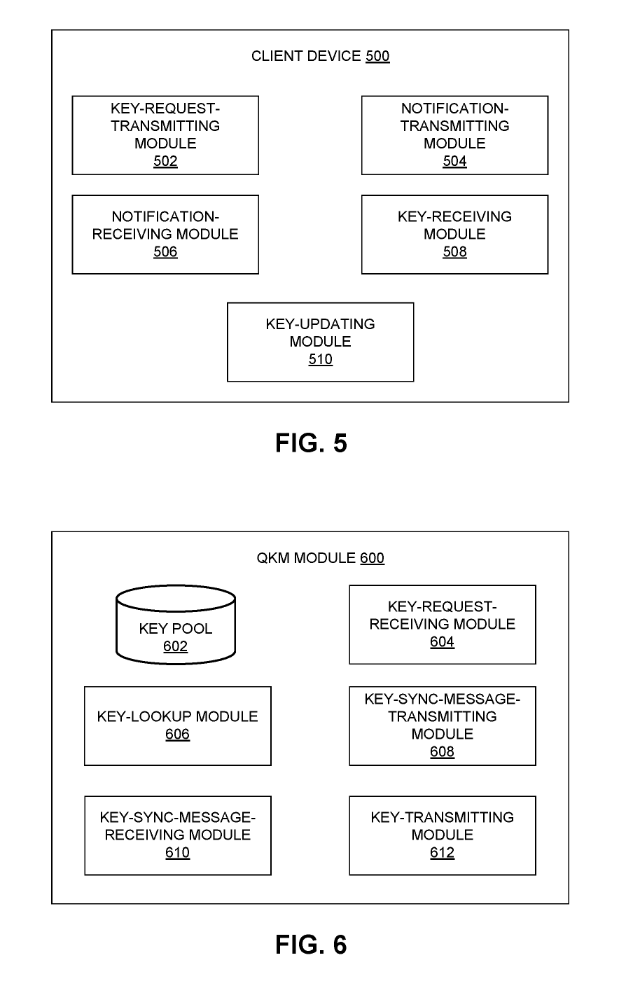

FIG. 5 presents a diagram illustrating the exemplary architecture of a client device, according to one embodiment. Client device 500 can be used for both the initiator side and the follower side. Client device 500 can include, for example, a tablet, a mobile phone, an electronic reader, a laptop computer, a desktop computer, or any other computing device. Client device 500 can communicate with other client devices or servers via a network. In some embodiments, client device 500 can include a key-request-transmitting module 502, a notification-transmitting module 504, a notification-receiving module 506, a key-receiving module 508, and a key-updating module 510.

Key-request-transmitting module 502 can be responsible for transmitting, on behalf of an application running on client device 500, a key request to a QKM module associated with client device 500. More specifically, the QKM module should be in the same secure zone as client device 500.

Notification-transmitting module 504 can be responsible for transmitting a notification to a communication partner (e.g., an application running on a remote client device), notifying the communication partner that the current application is requesting a quantum key. In some embodiments, the notification can include parameters (e.g., length and/or sequence number) associated with the quantum key requested by the current application. Notification-receiving module 506 can be responsible for receiving a notification from a communication partner.

Key-receiving module 508 can be responsible for receiving, from the corresponding QKM module, the requested quantum key. Key-updating module 510 can be responsible for updating the current encryption/decryption key using the received quantum key.

FIG. 6 presents a diagram illustrating the exemplary architecture of a quantum-key-management (QKM) module, according to one embodiment. QKM module 600 can be used for both the initiator side and the follower side. In some embodiments, QKM module 600 can include a key pool 602, a key-request-receiving module 604, a key-lookup module 606, a key-sync-message-transmitting module 608, a key-sync-message-receiving module 610, and a key-transmitting module 612.

Key pool 602 can be responsible for storing a plurality of quantum keys (e.g., shared secret keys obtained using a quantum-key-distribution scheme). In some embodiments, the quantum keys are symmetric keys, meaning that the key pool on the side of the initiator and the key pool on the side of the follower store identical sets of quantum keys. When an initiating application receives a key selected from the key pool on the side of the initiator, the following application receives an identical key selected from the key pool on the side of the follower.

Key-request-receiving module 604 can be responsible for receiving a key request from an application. The key request can include information associated with the requested key and information associated with a remote application. Key-request-receiving module 604 can also be responsible for parsing the received key request to obtain the key information as well as the information associated with the remote application. Key-lookup module 606 can be responsible for looking up the requested key in key pool 602.

Key-sync-message-transmitting module 608 can be responsible for transmitting a key-sync message to a remote QKM module associated with the remote application. Key-sync-message-receiving module 610 can be responsible for receiving a key-sync message from a remote QKM module. More specifically, when QKM module 600 is on the initiator side, key-sync-message-transmitting module 608 can transmit a key-sync message to the remote QKM module on the follower side prior to receiving a key-sync message from the remote QKM module. On the other hand, when QKM module 600 in in the follower side, key-sync-message-receiving module 610 can receive a key-sync message from the remote QKM module on the initiator side prior to transmitting a key-sync message to the remote QKM module. Key-transmitting module 612 can be responsible for transmitting the requested key to the requesting application. More specifically, key-transmitting module 612 transmits the requested key to the requesting application subsequent to receiving both the key request from the requesting application and the key-sync message from the remote QKM module.

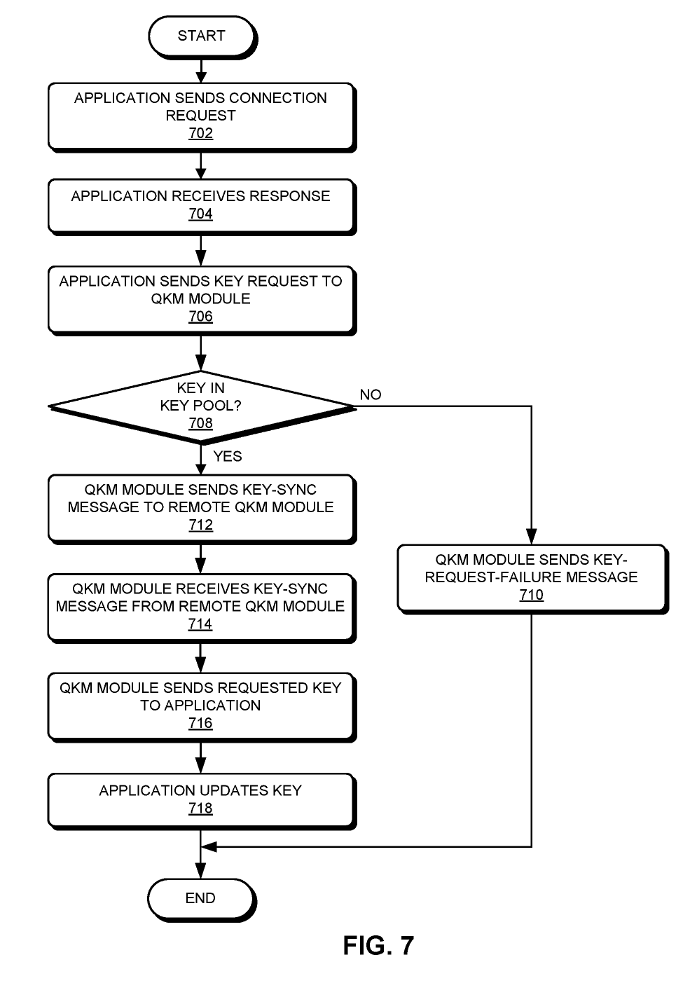

FIG. 7 presents a flowchart illustrating an exemplary quantum-key-distribution initiating process, according to one embodiment. During operation, an initiating application running on a local client device can send a connection request to a QKM module associated with the local client device (operation 702) and receive a response from the QKM module (operation 704). If the QKM module validates the initiating application, the QKM module can establish a secure link with the local client device according to a set of security rules.

The initiating application can then send a key request to the QKM module and a notification to a following application running on a remote client device (operation 706). The following application is the application to which the initiating application attempts to establish a secure communication channel. The key request can include one or more parameters (e.g., length and/or sequence number) associated with the requested key, as well as information (e.g., device identifier) associated with the following application and the remote client device. The QKM module determines whether the requested key exists in its key pool (operation 708). If not, a key-request-failure message can be sent to the initiating application (operation 710). If a key can be found, the QKM module can send a key-sync message to a different or remote QKM module associated with the following application (operation 712). The key-sync message notifies the remote QKM module that the local QKM module has found the requested key. In some embodiments, the key-sync message can include information associated with the requested key. If symmetric keys are used, meaning that the initiating and following applications share a secret key, the key-sync message can include information associated with the key needed by the following application.

Subsequent to transmitting the key-sync message to the different or remote QKM module, the local QKM module can receive a key-sync message from the remote QKM module, indicating that the remote QKM module has returned the requested key to the remote application (operation 714). The key-sync message can include information associated with the key sent to the remote application, thus allowing the local QKM module to verify that the correct key is requested locally. In some embodiments, the same QKM module can communicate with both the initiating application and the following application. In such a scenario, there is no longer a need to transmit or receive key-sync messages. In response to receiving the key-sync message from the remote QKM module, the local QKM module transmits the requested key to the initiating application (operation 716). The initiating application can then update its encryption/decryption key using the received key (operation 718).

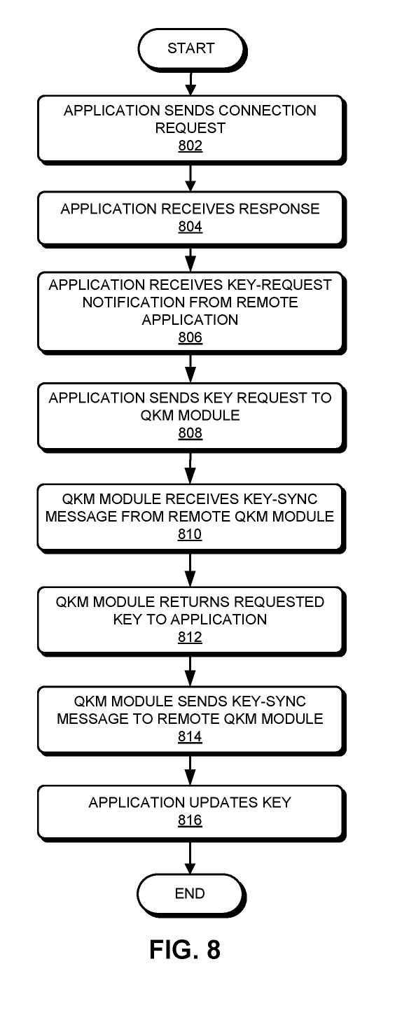

FIG. 8 presents a flowchart illustrating an exemplary quantum-key-distribution following process, according to one embodiment. During operation, a following application running on a local client device can send a connection request to a QKM module associated with the local client device (operation 802) and receive a response from the QKM module (operation 804). If QKM module validates the initiating application, the the QKM module can establish a secure link with the local client device according to a set of security rules.

The following application can receive a key-request notification from a remote initiating application (operation 806). Such a notification indicates that the remote initiating application has initiated a key-distribution operation by requesting a key from a QKM module associated with the remote initiating application. The key-request notification can include information associated with the requested key (e.g., length and/or sequence number of the requested key). In response to receiving the notification, the following application can send a key request to a QKM module associated with the following application (operation 808). The key request can include key information that is included in the key-request notification.

The local following QKM module can also receive a key-sync message from the QKM module associated with the remote initiating application (operation 810). The key-sync message indicates that the remote QKM module has found the requested key. In some embodiments, the key-sync message can also include the key information to allow the following application to verify whether the correct key is being requested.

In response to receiving both the key request and the key-sync message, the local QKM module associated with the following application can return the requested key to the following application (operation 812). The local QKM module can also send a key-sync message to the remote QKM module, indicating that the following application has received the key and prompting the remote QKM module to return the requested key to the initiating application (operation 814). Subsequently, the following application can update its encryption/decryption key using the received key (operation 816).

In general, embodiments of the present invention facilitate the decoupling between the QKD process and the cryptographic process, thus making the quantum-key-based cryptographic applications more robust. More specifically, there is no long a need to develop special quantum equipment for different cryptographic scenarios. Secure communication between applications can be achieved by each individual application requesting from its own QKM engine the shared quantum key. Synchronization messages passed between the QKM engines ensures that the correct keys can be obtained by each application.

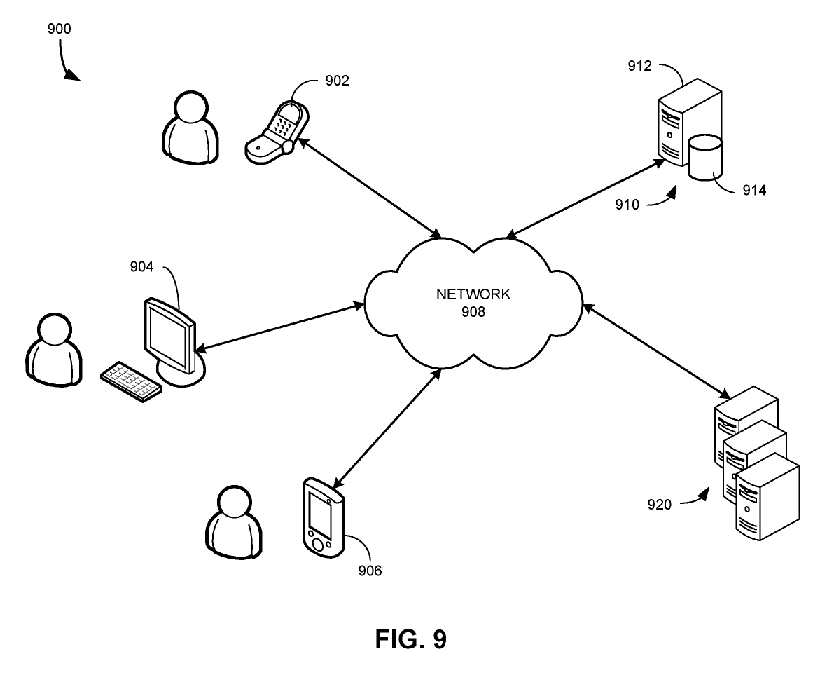

FIG. 9 illustrates an exemplary client-server network environment for implementing the disclosed quantum-key-distribution technology, in accordance with some embodiments described herein. A network environment 900 includes a number of electronic devices 902, 904 and 906 communicably connected to a server 910 by a network 908. One or more remote servers 920 are further coupled to the server 910 and/or the one or more electronic devices 902, 904 and 906.

In some exemplary embodiments, electronic devices 902, 904 and 906 can be computing devices such as laptop or desktop computers, smartphones, PDAs, portable media players, tablet computers, televisions or other displays with one or more processors coupled thereto or embedded therein, or other appropriate computing devices that can be used for displaying a web page or web application. In one example, the electronic devices 902, 904 and 906 store a user agent such as a browser or application. In the example of FIG. 9, electronic device 902 is depicted as a smartphone, electronic device 904 is depicted as a desktop computer, and electronic device 906 is depicted as a PDA.

Server 910 includes a processing device 912 and a data store 914. Processing device 912 executes computer instructions stored in data store 914, for example, to assist in scheduling a customer-initiated service or a service-provider-initiated service between a service provider and a customer at electronic devices 902, 904 and 906 during a service scheduling process.

In some exemplary aspects, server 910 can be a single computing device such as a computer server. In other embodiments, server 910 can represent more than one computing device working together to perform the actions of a server computer (e.g., cloud computing). The server 910 may host the web server communicably coupled to the browser at the client device (e.g., electronic devices 902, 904 or 906) via network 908. In one example, the server 910 may host a client application for scheduling a customer-initiated service or a service-provider-initiated service between a service provider and a customer during a service scheduling process. Server 910 may further be in communication with one or more remote servers 920 either through the network 908 or through another network or communication means.

The one or more remote servers 920 may perform various functionalities and/or storage capabilities described herein with regard to the server 910, either alone or in combination with server 910. Each of the one or more remote servers 920 may host various services. For example, servers 920 may host services providing information regarding one or more suggested locations, such as web pages or websites associated with the suggested locations; services for determining the location of one or more users, or establishments; search engines for identifying results for a user query; one or more user review or query services; or one or more other services providing information regarding one or more establishments, customers and/or review or feedback regarding the establishments.

Server 910 may further maintain or be in communication with social networking services hosted on one or more remote servers 920. The one or more social networking services may provide various services and may enable users to create a profile and associate themselves with other users at a remote social networking service. The server 910 and/or the one or more remote servers 920 may further facilitate the generation and maintenance of a social graph including the user-created associations. The social graphs may include, for example, a list of all users of the remote social networking service and their associations with other users of a remote social networking service.

Each of the one or more remote servers 920 can be a single computing device such as a computer server or can represent more than one computing device working together to perform the actions of a server computer (e.g., cloud computing). In one embodiment server 910 and one or more remote servers 920 may be implemented as a single server or a cluster of servers. In one example, server 910 and one or more remote servers 920 may communicate through the user agent at the client device (e.g., electronic devices 902, 904, or 906) via network 908.

Users may interact with the system hosted by server 910, and/or one or more services hosted by remote servers 920, through a client application installed at the electronic devices 902, 904, and 906. Alternatively, the user may interact with the system and the one or more social networking services through a web-based browser application at the electronic devices 902, 904, 906. Communication among client devices 902, 904, and 906 and the system, and/or one or more services, may be facilitated through a network (e.g., network 908).

Communications among the client devices 902, 904, 906, server 910 and/or one or more remote servers 920 may be facilitated through various communication protocols. In some aspects, client devices 902, 904, 906, server 910 and/or one or more remote servers 920 may communicate wirelessly through a communication interface (not shown), which may include digital signal processing circuitry where necessary. The communication interface may provide for communications under various modes or protocols, including Global System for Mobile communication (GSM) voice calls; Short Message Service (SMS), Enhanced Messaging Service (EMS), or Multimedia Messaging Service (MMS) messaging; Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, including via the use of a Bluetooth-enabled device, Wi-Fi®, or other such transceiver.

Network 908 can include, for example, any one or more of a personal area network (PAN), a local area network (LAN), a campus area network (CAN), a metropolitan area network (MAN), a wide area network (WAN), a broadband network (BBN), the Internet, and the like. Further, network 908 can include, but is not limited to, any one or more of the following network topologies, including a bus network, a star network, a ring network, a mesh network, a star-bus network, a tree or hierarchical network, and the like.

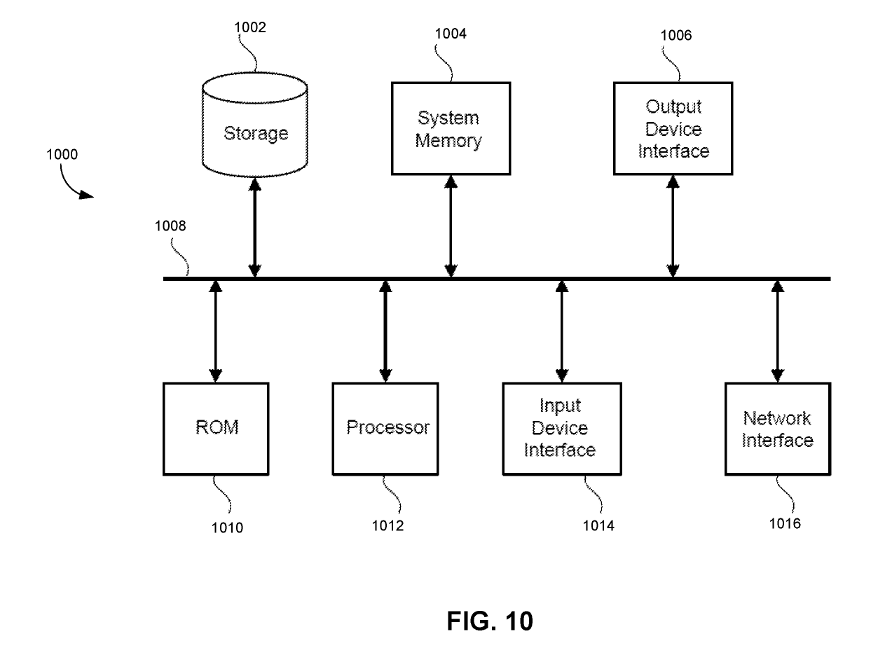

FIG. 10 conceptually illustrates an electronic system with which some implementations of the subject technology are implemented. Electronic system 1000 can be a client, a server, a computer, a smartphone, a PDA, a laptop, or a tablet computer with one or more processors embedded therein or coupled thereto, or any other sort of electronic device. Such an electronic system includes various types of computer-readable media and interfaces for various other types of computer-readable media. Electronic system 1000 includes a bus 1008, processing unit(s) 1012, a system memory 1004, a read-only memory (ROM) 1010, a permanent storage device 1002, an input device interface 1014, an output device interface 1006, and a network interface 1016.

Bus 1008 collectively represents all system, peripheral, and chipset buses that communicatively connect the numerous internal devices of electronic system 1000. For instance, bus 1008 communicatively connects processing unit(s) 1012 with ROM 1010, system memory 1004, and permanent storage device 1002.

From these various memory units, processing unit(s) 1012 retrieves instructions to execute and data to process in order to execute the processes of the subject disclosure. The processing unit(s) can be a single processor or a multi-core processor in different implementations.

ROM 1010 stores static data and instructions that are needed by processing unit(s) 1012 and other modules of electronic system 1000. Permanent storage device 1002, on the other hand, is a read-and-write memory device. This device is a non-volatile memory unit that stores instructions and data even when electronic system 1000 is off. Some implementations of the subject disclosure use a mass-storage device (such as a magnetic or optical disk and its corresponding disk drive) as permanent storage device 1002.

Other implementations use a removable storage device (such as a floppy disk, flash drive, and its corresponding disk drive) as permanent storage device 1002. Like permanent storage device 1002, system memory 1004 is a read-and-write memory device. However, unlike storage device 1002, system memory 1004 is a volatile read-and-write memory, such as a random access memory. System memory 1004 stores some of the instructions and data that the processor needs at runtime. In some implementations, the processes of the subject disclosure are stored in system memory 1004, permanent storage device 1002, and/or ROM 1010. From these various memory units, processing unit(s) 1012 retrieves instructions to execute and data to process in order to execute the processes of some implementations.

Bus 1008 also connects to input and output device interfaces 1014 and 1006, respectively. Input device interface 1014 enables the user to communicate information and select commands for the electronic system. Input devices used with input device interface 1014 include, for example, alphanumeric keyboards and pointing devices (also called “cursor control devices”). Output device interface 1006 enables, for example, the display of images generated by electronic system 1000. Output devices used with output device interface 1006 include, for example, printers and display devices, such as cathode ray tubes (CRT) or liquid crystal displays (LCD). Some implementations include devices such as a touchscreen that functions as both input and output devices.

Finally, as shown in FIG. 10, bus 1008 also couples electronic system 1000 to a network (not shown) through a network interface 1016. In this manner, the computer can be a part of a network of computers (such as a local area network (“LAN”), a wide area network (“WAN”), or an intranet, or a network of networks, such as the Internet. Any or all components of electronic system 1000 can be used in conjunction with the subject disclosure.

These functions described above can be implemented in digital electronic circuitry; or in computer software, firmware or hardware. The techniques can be implemented using one or more computer program products. Programmable processors and computers can be included in or packaged as mobile devices. The processes and logic flows can be performed by one or more programmable processors or by one or more programmable logic circuitries. General and special purpose computing devices and storage devices can be interconnected through communication networks.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for distributing quantum keys between first and second applications running on first and second client devices, respectively, the method comprising:
transmitting, by the first application running on the first client device, a first key request to a first quantum-key-management (QKM) module managing a first set of quantum keys;
transmitting, by the first application, a notification to the second application running on the second client device, wherein the notification prompts the second application to transmit a second key request to a second QKM module managing a second set of quantum keys; and
receiving, from the first QKM module, a first quantum key based on the first key request, in response to the first QKM module determining that the second application receives a second quantum key based on the second key request.

2. The computer-implemented method of claim 1, wherein the first key request comprises parameters associated with the first quantum key, and wherein the parameters associated with the first quantum key comprise a length or a sequence number associated with the first quantum key.

3. The computer-implemented method of claim 2, wherein the notification comprises the parameters associated with the first quantum key.

4. The computer-implemented method of claim 2, further comprising:
performing a lookup operation, by the first quantum-key-management (QKM) module, in the first set of quantum keys based on the parameters associated with the first quantum key;
in response to determining that the first set of quantum keys comprises the first quantum key, obtaining the first quantum key; and
in response to determining that the first set of quantum keys does not comprise the first quantum key, returning a failure message to the first application.

5. The computer-implemented method of claim 1, wherein the first key request comprises a device identifier associated with the second QKM module, and wherein the method further comprises:
identifying, by the first QKM module, the second QKM module based on the device identifier; and
transmitting, by the first QKM module, a first key-sync message to the second QKM module, wherein the first key-sync message indicates that the first quantum key is available.

6. The computer-implemented method of claim 5, wherein the first key-sync message comprises parameters associated with the first quantum key.

7. The computer-implemented method of claim 1, wherein determining that the second client device receives a second quantum key comprises receiving, from the second QKM module, a second key-sync message.

8. The computer-implemented method of claim 7, wherein the second key-sync message comprises parameters associated with the second quantum key.

9. The computer-implemented method of claim 1, wherein the first and second sets of quantum keys are obtained via a quantum-key-distribution process, and wherein the first and second quantum keys are symmetric encryption keys.

10. The computer-implemented method of claim 1, further comprising:
updating, by the first application running on the first client device, an encryption key using the first quantum key; and
updating, by the second application running on the second client device, an encryption key using the second quantum key, thereby establishing a secure communication channel between the first and second applications.

11. A computing system, comprising:
a processor; and
a storage device coupled to the processor and storing instructions which when executed by the processor cause the processor to perform a method for distributing quantum keys between first and second applications running on first and second client devices, respectively, wherein the method comprises:
transmitting, by the first application running on the first client device, a first key request to a first quantum-key-management (QKM) module managing a first set of quantum keys;
transmitting, by the first application, a notification to the second application running on the second client device, wherein the notification prompts the second application to transmit a second key request to a second QKM module managing a second set of quantum keys; and
receiving, from the first QKM module, a first quantum key based on the first key request, in response to the first QKM module determining that the second client device receives a second quantum key based on the second key request.

12. The computing system, of claim 11, wherein the first key request comprises parameters associated with the first quantum key, and wherein the method further comprises:
performing a lookup operation, by the first quantum-key-management (QKM) module, in the first set of quantum keys based on the parameters associated with the first quantum key;
in response to determining that the first set of quantum keys comprises the first quantum key, obtaining the first quantum key; and
in response to determining that the first set of quantum keys does not comprise the first quantum key, returning a failure message to the first application.

13. The computing system of claim 11, wherein the first key request comprises a device identifier associated with the second QKM module, and wherein the method further comprises:
identifying, by the first QKM module, the second QKM module based on the device identifier; and
transmitting, by the first QKM module, a first key-sync message to the second QKM module, wherein the first key-sync message comprises parameters associated with the first quantum key, and wherein the first key-sync message indicates that the first quantum key is available.

14. The computing system of claim 11, wherein determining that the second client device receives a second quantum key comprises receiving, from the second QKM module, a second key-sync message; and wherein the second key-sync message comprises parameters associated with the second quantum key.

15. The computing system of claim 11, wherein the first and second sets of quantum keys are obtained via a quantum-key-distribution process, and wherein the first and second quantum keys are symmetric encryption keys.

16. The computing system of claim 11, wherein the method further comprises:
updating, by the first application running on the first client device, an encryption key using the first quantum key; and
updating, by the second application running on the second client device, an encryption key using the second quantum key, thereby establishing a secure communication channel between the first and second applications.

17. A computing system, comprising:
a processor; and
a storage device coupled to the processor and storing instructions which when executed by the processor cause the processor to perform a method for distributing quantum keys between first and second applications running on first and second client devices, respectively, wherein the method comprises:
receiving, by the second application running on the second client device, a key-request notification from the first application running on the first client device, wherein the key-request notification indicates that the first application has sent a request for a first quantum key to a first quantum-key-management (QKM) module managing a first set of quantum keys;
transmitting, by the second application, a request for a second quantum key to a second QKM module managing a second set of quantum keys;
receiving, from the second QKM module, the second quantum key in response to the second QKM module receiving a first key-sync message from the first QKM module; and
transmitting, by the second QKM module, a second key-sync message to the first QKM module, thereby prompting the first QKM module to return the first quantum key to the first application.

18. The computing system of claim 17, wherein the first key-sync message comprises parameters associated with the first quantum key, and wherein the method further comprises:
performing a lookup operation, by the second QKM module, in the second set of quantum keys based on the parameters associated with the first quantum key;
in response to determining that the second set of quantum keys comprises the second quantum key, obtaining the second quantum key; and
in response to determining that the second set of quantum keys does not comprise the first quantum key, returning a failure message to the second application.

19. The computing system of claim 17, wherein the second key-sync message comprises information associated with the second quantum key.

20. The computing system of claim 17, wherein the first and second sets of quantum keys are obtained via a quantum-key-distribution process, and wherein the first and second quantum keys are symmetric encryption keys.
